(19) United States
(12) Patent Application Publication
(10) Pub. No.: US 2026/0197575 A1
(43) Pub. Date: Jul. 9, 2026

(54) AUDIO COMPRESSION AND STORAGE USING EAR-WORN DEVICE

(71) Applicant: Starkey Laboratories, Inc., Eden Prairie, MN (US)

(72) Inventors: Achintya Kumar Bhowmik, Cupertino, CA (US); Henning Schepker, Wardenburg (DE); Mohammed Modar Halimeh, Erlangen/Bayern (DE)

(21) Appl. No.: 19/556,805

(22) Filed: Mar. 4, 2026

Related U.S. Application Data
(63) Continuation-in-part of application No. 19/318,033, filed on Sep. 3, 2025.
(60) Provisional application No. 63/690,716, filed on Sep. 4, 2024.
(60) Provisional application No. 63/994,496, filed on Mar. 2, 2026.
(60) Provisional application No. 63/994,546, filed on Mar. 2, 2026.
(60) Provisional application No. 63/994,532, filed on Mar. 2, 2026.

(51) Int. Cl. H04R 1/10; H04R 25/00

(52) U.S. Cl. CPC H04R 1/1041; H04R 1/1091; H04R 25/554; H04R 2225/55; H04R 2225/61; H04R 2420/07

(57) ABSTRACT

A method of saving audio data on an ear-worn device is provided. The method comprises connecting an ear-worn device to an external device; receiving a request for audio data to be sent from the external device to the ear-worn device; modifying a first audio data file on the external device to create a plurality of audio tokens, wherein the data size of the plurality of tokens is smaller than the first audio data file; sending the audio tokens from the external device to the ear-worn device; and saving the audio tokens in a non-volatile memory element of the ear-worn device. Modifying the audio data on the external device can include utilizing a neural audio codec. This method can enable efficient compression and storage of audio data suitable for playback on ear-worn devices with limited memory capacity.

This application is a continuation in part of U.S. patent application Ser. No. 19/318,033, filed Sep. 3, 2025, which claims the benefit of U.S. Provisional Patent Application No. 63/690,716, filed Sep. 4, 2024, each of which is incorporated herein by reference in their entirety. This application also claims priority to U.S. Provisional Patent Application No. 63/994,496, filed Mar. 2, 2026, to U.S. Provisional Patent Application No. 63/994,546, filed Mar. 2, 2026, and to U.S. Provisional Patent Application No. 63/994,532, filed Mar. 2, 2026, all of which are incorporated by reference in their entirety.

### FIELD

Embodiments herein relate to ear-worn devices and more particularly to ear-worn devices storing audio data.

### BACKGROUND

Ear-worn devices are configured to provide audio input to the ears of a user. Some examples of ear-worn devices or hearing devices include headsets, hearing aids, earbuds, cochlear implants, bone conduction devices, and personal listening devices. Ear-worn devices often have power and memory limitations that can make listening to audio content difficult in some situations.

Further, many users of ear-worn devices would like the option to listen to audio content such as audio books, music, and podcasts without having to carry another electronic device such as a smartphone or tablet or having to wirelessly stream from an accessory device.

### SUMMARY

In an embodiment, a method of saving audio data on an ear-worn device, can be included, the method can include connecting an ear-worn device to an external device, receiving a request for audio data to be sent from the external device to the ear-worn device, modifying a first audio data file on the external device to create a plurality of audio tokens, wherein the data size of the plurality of tokens can be smaller than the first audio data file, sending the audio tokens from the external device to the ear-worn device, and saving the audio tokens in a non-volatile memory element of the ear-worn device.

In an embodiment, the modifying the first audio data file to create the plurality of audio tokens utilizes an encoder and a quantizer stored on the external device.

In an embodiment, the method can further include decoding the audio tokens on the ear-worn device utilizing a decoder that corresponds with the encoder of the external device.

In an embodiment, the method can further include producing an audio output with a receiver of the ear-worn device based on the decoded audio tokens.

In an embodiment, the external device includes a smartphone.

In an embodiment, the requested audio data file includes at least one of a song, a podcast, an audio book, a playlist of songs, or a playlist of podcasts.

In an embodiment, the ear-worn device includes a left ear-worn device and a right ear-worn device, wherein the left ear-worn device includes a left non-volatile memory element, and the right ear-worn device includes a right non-volatile memory element.

In an embodiment, the first audio data file includes multichannel audio data can include two or more channels of audio data, wherein modifying the first audio data further includes separating the two or more channels of audio data into a right channel audio tokens and a left channel audio tokens, wherein saving the audio tokens includes saving the right channel audio tokens in the right non-volatile memory element and saving the left channel audio tokens in the left non-volatile memory element.

In an embodiment, the method can further include modifying the first audio data prior to creating audio tokens according to an audio profile.

In an embodiment, the audio profile includes parameters of the ear-worn device.

In an embodiment, the audio profile includes device parameters that define a frequency range output of the ear-worn device, and modifying the first audio data file includes removing audio content that cannot be output from the ear-worn device based on the device parameters.

In an embodiment, the audio profile includes data related to a user's hearing capabilities.

In an embodiment, the user's hearing capabilities includes at least one of a frequency range that the user cannot hear, a frequency range that the user can have trouble hearing, and a frequency range that the user can hear.

In an embodiment, the non-volatile memory element can be configured to store at least 1 MB of data and not more than 1 GB of data.

In an embodiment, the audio tokens data storage requirement can be at least 30% smaller than the first audio data.

In an embodiment, the encoder includes a neural network.

In an embodiment, the decoder includes a neural network.

In an embodiment, a ear-worn device can be included having a wireless communication device to receive data from one or more external devices, a non-volatile memory to store received data, a speaker to output sound based on received audio signals, and control circuitry can include one or more processors and operatively coupled to the wireless communication device, the non-volatile memory, and the speaker, the control circuitry configured to receive a plurality of audio tokens using the wireless communication device, the plurality of audio tokens representative of an audio data file, save the audio tokens in the non-volatile memory element, generate an audio signal based on the plurality of audio tokens using a decoder can include a neural network, and provide the audio signal to the speaker for sound generation.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following figures (FIGS.), in which:

FIG. 1 is a schematic view of a hearing assistance system in accordance with various embodiments herein.

FIG. 2 is a schematic view of the hearing assistance system shown in FIG. 1 in accordance with various embodiments herein.

FIG. 3 is a schematic view of a hearing assistance system in accordance with various embodiments herein.

FIG. 4 is a schematic view of the hearing assistance system shown in FIG. 3 in accordance with various embodiments herein.

FIG. 5 is a schematic view of the hearing assistance system shown in FIG. 3 in accordance with various embodiments herein.

FIG. 6 is a schematic view of a user interface of an external device in accordance with various embodiments herein.

FIG. 7 is a schematic view of a user interface of an external device in accordance with various embodiments herein.

FIG. 8 is a schematic view of a user interface of an external device in accordance with various embodiments herein.

FIG. 9 is a schematic view of a user interface of an external device in accordance with various embodiments herein.

FIG. 10 is a schematic view of a user interacting with an ear-worn device in accordance with various embodiments herein.

FIG. 11 is a block diagram view of components of an ear-worn device in accordance with various embodiments herein.

FIG. 12 is a flow chart of a method of saving audio data on an ear-worn device in accordance with various embodiments herein.

FIG. 13 is a flow chart of a method of saving audio data on an ear-worn device in accordance with various embodiments herein.

FIG. 14 is a flow chart of a method of saving audio data on an ear-worn device in accordance with various embodiments herein.

While embodiments are susceptible to various modifications and alternative forms, specifics thereof have been shown by way of example and drawings and will be described in detail. It should be understood, however, that the scope herein is not limited to the particular aspects described. On the contrary, the intention is to cover modifications, equivalents, and alternatives falling within the spirit and scope herein.

### DETAILED DESCRIPTION

When a user wants to listen to audio content through an ear-worn device (e.g., a hearing aid), the user first connects the ear-worn device to an external computing device. The audio content is stored on the external device and the external device can stream the audio content (e.g., transmit data packets containing audio data) to the user's ear-worn device for playback through one or more receivers (e.g., speakers) of the ear-worn device. Wireless audio streaming from an external device may use energy from the ear-worn device's battery faster than accessing local memory of the ear-worn device due to the increased power required for wireless communication. Another constraint is that local memory of the ear-worn device may be limited due to a small device format and may not be sufficient to store a large audio catalogue.

In some cases, a user might know they will not have access to the external device during a time in which they want to listen to the audio content. Ear-worn devices, such as hearing aids or other hearing devices, can include a memory component. However, the memory component has limited storage, much of which can be occupied by programs, such as programs related to hearing assistance. The limited available storage on-board many ear-worn devices makes storage of a larger quantity of audio content in the traditional manner challenging, because audio content files can be relatively large compared to the limited storage typical in the ear-worn device. Further, when an external device is available, wireless audio streaming from an external device, such as through a Bluetooth connection, can drain a limited battery on the ear-worn device. Storing the desired audio content on the ear-worn device can reduce the load on the battery.

The user and wearer of the ear-worn device may desire to play audio content without the need to stream such audio content from the external device. Devices and methods provided herein can provide the ability to store increased amounts of audio content on the ear-worn device without sacrificing audio quality for a particular user.

In various embodiments of the systems and methods described herein, a user can access audio content on an ear-worn device without the need to actively stream the audio content from an external device. Various embodiments provided herein allow users to access audio content without using an external device (e.g., a smartphone) and/or without using an active wired or wireless connection to an external device. In various embodiments, audio content can be compressed and stored on an ear-worn device in a manner that can reduce the audio content file size particularly suited for the ear-worn devices and their users. Further, since the ear-worn device does not need to maintain a connection with the external device, the demand on the battery of the ear-worn device can be greatly reduced.

Various embodiments provided herein include a method of saving audio data on an ear-worn device. An ear-worn device can be connected to an external device. The user can request audio data to be sent from the external device to the ear-worn device. Prior to sending the audio data to the ear-worn device, the external device can modify the audio data to create a compressed version of the audio data. The audio data can be modified according to an audio profile, which can include limitations of the ear-worn device, and/or limitations or preferences of the user. The compressed version of the audio data can be sent to and saved/stored in a non-volatile memory element or non-transitory memory element in the ear-worn device. The user can access the saved audio data at a later time to listen to the audio data through the ear-worn device without the external device. As a result, the user can listen to the audio data without needing to stream the audio from the external device. Additionally, the original audio data can be compressed to reduce the space needed in the ear-worn device memory component to store the audio data for future playback.

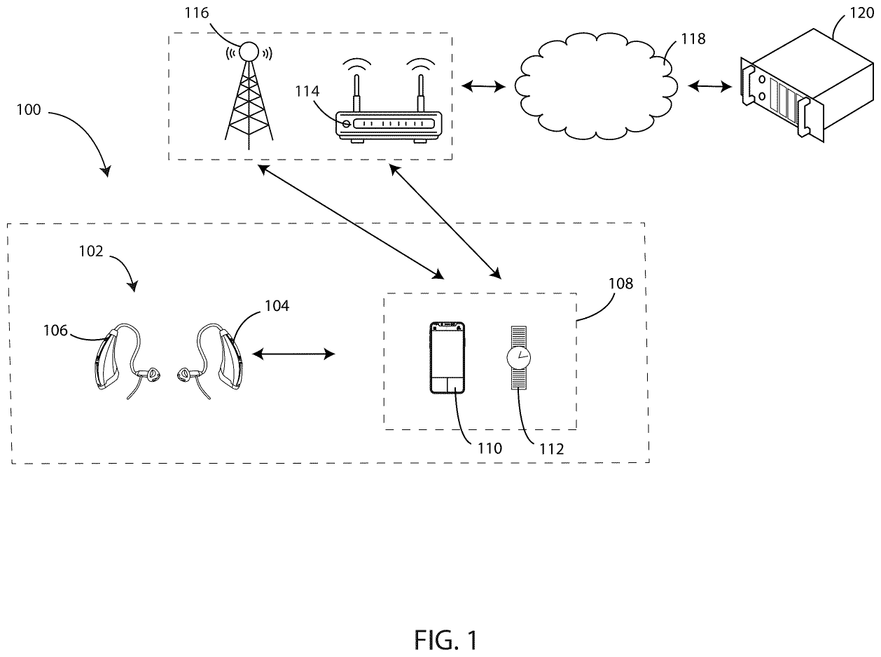

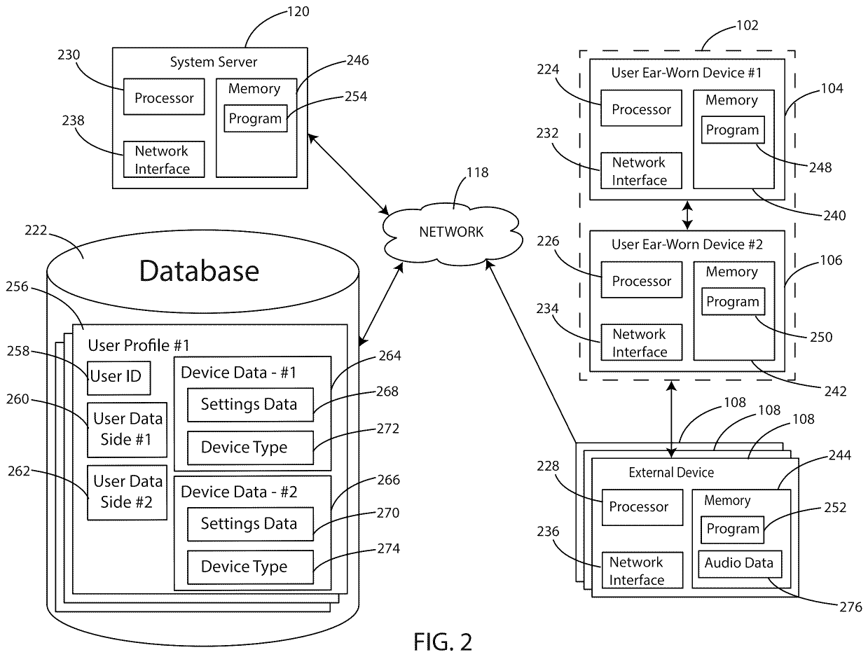

Hearing Assistance System with Audio Profile Stored on a System Server (FIG. 1-2)

Referring now to FIG. 1, a perspective view of a hearing assistance system 100 is shown in accordance with various embodiments herein. The system 100 can include an ear-worn device 102, an external device 108, and a system server 120. The external device 108 can communicate with the system server 120 over a network 118, such as through an Internet connection 114 or a cellular connection 116.

The system 100 can process audio content, in the form of an audio data file, that is saved on the external device according to an audio profile stored on the system server 120, or other storage locations. The processed audio content can then be sent to and saved on the ear-worn device 102. In various embodiments, the audio content can include at least one of a song, a podcast, an audio book, a playlist of songs, or a playlist of podcasts. The hearing assistance system 100 can include at least one ear-worn device 102. In various embodiments, the ear-worn device 102 can include a first ear-worn device 104 and a second ear-worn device 106, such as a right ear-worn device 104 and a left ear-worn device 106. In various embodiments, each ear-worn device 104, 106 can contain a battery and a non-volatile memory element. In the example of FIG. 1, the hearing assistance system 100 includes two ear-worn devices 104, 106. However, in some embodiments, the hearing assistance system 100 may include a single ear-worn device 102. User's may have different hearing abilities or physical characteristics between their left and right ears. As a result, device 104 can be different than device 106. The differences can be physical or functional.

In various embodiments, the system can include an external device 108. The external device 108 can be a computing device, such as a device that includes a memory component and a processing component. In some embodiments, the external device 108 can include a smartphone 110 or a smartwatch 112. In other examples, the external device 108 can include smart glasses, a laptop computer, a tablet computer, a personal computer, or the like.

FIG. 2 is a schematic view of various components of a system in accordance with various embodiments herein. FIG. 2 shows a schematic of the system 100 that can be used to modify audio data files on the external device 108 and save the modified audio data files on the ear-worn device 102, such that a user can access the audio data files for later playback without the use of the external device 108. The system 100 can include an ear-worn device 102, an external device 108, a system server 120, and a database 222.

In various embodiments, the external device 108 and the system server 120 can be computer systems or include computer systems. Similarly, in some embodiments the ear-worn device 102 can include one or more computer systems, such as the first ear-worn device 104 including a computer system and the second ear-worn device 106 including a computer system. In various embodiments, these computing systems can each include a processor 224, 226, 228, 230, a network interface 232, 234, 236, 238 to allow communications over network 118, and memory and/or storage 240, 242, 244, 246.

The memory elements 240, 242 of the ear worn device 102, in most cases, can have a significantly smaller amount of storage compared to the memory elements 244, 246 of an external device 108 and the system server 120. As an example, a memory element 244, 246 of an external device 108 or a system server 120 can store multiple terabytes of data, whereas a memory element 240, 242 of an ear-worn device 102 can be limited to tens of megabytes. A memory element 244, 246 of an external device 108 or a system server 120 can include volatile and/or non-volatile memory.

In various embodiments, memory 240, 242 can be non-volatile or non-transitory memory. In various embodiments, memory elements 240, 242 are each configured to store at least 1 MB of data and not more than 1 GB of data.

In various embodiments, the memory elements 240, 242 of the ear worn devices 102 can have a limited amount of storage available for audio data, such as a result of storing programs 248, 250. The memory elements 240, 242 can store programs 248, 250 that can utilize the majority of the storage available in the memory elements 240, 242. These programs 248, 250 can provide the standard functions for the ear-worn device, such as the amplification of audio.

In some embodiments, a program 248, 250 can take up to at least 50% of the storage capacity of a memory element 240, 242. In some embodiments, a program 248, 250 can take up to at least 55%, 60%, 65%, 70%, 75%, 80%, 85%, 90% or 95% of the storage capacity of a memory element 240, 242. As a result, less than 50%, 45%, 40%, 35%, 30%, 25%, 20%, 15%, 10%, or 5% of the total storage capacity of a memory element 240, 242 can be available for audio data storage.

Existing ear-worn devices typically include memory elements that are configured to store significantly less than 1 GB of data due to various constraints including cost and size. As memory elements continue to allow for increased data storage, memory elements in ear-worn devices may approach or even exceed a capability to store 1 GB of data. However, existing memory elements configured to store 1 GB of data or more may be prohibitively large and/or expensive for use in existing ear-worn devices. Accordingly, memory elements 240, 242 may each be configured to store no more than 512 MB of data or 256 MB. In various embodiments, the memory elements 240, 242 may each be configured to store no more than 128 MB of data. In further embodiments, the memory elements 240, 242 may each be configured to store no more than 64 MB of data. In still further embodiments, the memory elements 240, 242 may each be configured to store no more than 32 MB of data.

The memory 240, 242, 244, 246 is shown in FIG. 2 as including programming 248, 250, 252, 254 that can control the processors 224, 226, 228, 230. It should be understood that other devices that include computing systems can also be a part of the system and include similar elements, such as a processor, network interface, memory, and computer programming.

The memory 244 of the external device 108 can further include the audio content 276. The audio content 276 can include audio data or digital audio. The audio data can include one or more audio data files. The audio data can be in one of various file formats including MP3, AAC, Ogg Vorbis, FLAC, WAV, AIFF, DSD, and PCM.

In some embodiments, the external device 108 and the system server 120 can take the form of or include a standard computer system, or, in some embodiments, can take the form of or include a mobile device, such as a smartphone or tablet computer. The devices 108, 120 can also be implemented using a plurality of separate, individual computing devices.

The computer systems can operate application software or browser software, such as programs 248, 250, 252, 254, which can be stored in memory 240, 242, 244, 246 on the respective devices. The programs can allow the devices to communicate over the network 118 as part of the system 100. In particular, the programming 252 can at least allow communication with the server 120 and/or database 222 over the network 118.

The computer of devices 102, 108, 120 can be a computing device that includes a processor for processing computer programming instructions. In most cases, the processor can be a CPU. Various CPU devices are possible, such as those created by Intel Corporation (Santa Clara, California), Advanced Micro Devices, Inc (Santa Clara, California), or a RISC processer produced according to the designs of Arm Holdings PLC (Cambridge, England).

Additionally, the system server 120 and external device 108 can include memory element 244, 246. The memory elements 244, 246 can be in the form of both temporary, random-access memory (RAM) and more permanent storage such a magnetic disk storage, FLASH memory, or another non-transitory (also referred to as permanent) storage medium. The memory and storage, which can be referred to collectively as “memory”, can contain both programming instructions and data. In various embodiments, both programming and data can be stored permanently on non-transitory storage devices and transferred into RAM when needed, such as for processing or analysis. In some embodiments, the computers can include a graphics processing unit (or GPU) for processing visual input and outputs.

In various embodiments, the various data can be stored locally and/or stored remotely. In FIG. 2, various data can be stored in database 222. In many embodiments, the database 222 can be a portion of the system server 120. In other embodiments, the database 222 can be a separate element from the system server 120. In some embodiments, the database 222 can consist of local storage on the various devices included in the system 100.

In various embodiments, the database 222 can include defined database entities that, in some embodiments, can constitute database tables in a relational database. In other embodiments, entities may represent database objects or any other type of database entity usable with a computerized database. In various embodiments, the phrase database entity can refer to data records in a database, which can include a row in a database table, an instantiation of a database object, or any other populated database entity. Data within this database 222 can be “associated” or “linked” with other data. This association can be implemented in a variety of techniques depending on the technology used to store and manage the database, such as through formal relationships in a relational database or through established relationships between objects in an object-oriented database.

Database 222 can include a plurality of audio profiles 256, such as one audio profile 256 for each device 102 or user. In various embodiments, the audio profile 256 can include data for a user. To relate a specific user with a specific audio profile 256, the audio profile 256 can include a user ID 258 or other user identifying information. In some embodiments, the audio profile 256 can be stored in a memory element 246 of the system server. The external device 108 can receive or access the audio profile 256 over the network 118.

The audio profile 256 can include data related to the device 102 or devices utilized by and assigned to a particular user, which are often selected based on the hearing abilities of the user. Users frequently have different hearing abilities between their two ears. As such, the audio profile 256 can include user data for a first side 260 (e.g., the user's right side) and user data for a second side 262 (e.g., the user's left side), such as data for the user's right ear hearing capabilities and data for the user's left ear hearing capabilities. In some embodiments, the audio profile 256 can include data related to the user's hearing capabilities, such as frequency ranges that the user cannot hear, frequency ranges that the user has trouble hearing, and/or frequency ranges that the user can hear.

The audio profile 256 can include device data 264, 266 related to the device 102 or devices 104, 106 that are assigned to the user. A first device 104 and a second device 106 can be configured differently to account for the differences between the user's hearing abilities on each side. The first device data 264 can include data related to a first device 104 and the second device data 266 can include data related to a second device 106. In various embodiments, the device data 264, 266 can include settings data 268, 270. Setting data can include settings that are programmed in the device 104, 106. As an example, in some embodiments, the settings data 268, 270 can include data related to how audio is modified for the user, such as to account for the user's hearing abilities or the user's preferences. In some embodiments, the setting data 268, 270 can include frequency ranges that are amplified more or less compared to other frequency ranges.

In various embodiments, the first (unmodified) audio data file on the external device 108 can include a stereo signal that includes a first (unmodified) right device audio data file and a first (unmodified) left device audio data file. The modifying step can include creating a second (modified) right device audio data file and a second (modified) left device audio data file, where the modifications are made according to the audio profile to create smaller audio data files. In various embodiments, the sum of the file sizes of the second right device audio data and the second left device audio data will be smaller than the first audio data file.

In various embodiments, the audio profile can include a left audio profile and a right audio profile. Modifying the audio data can include creating a second (modified) right device audio data file in accordance with parameters defined in the right audio profile and creating a second (modified) left device audio data file in accordance with parameters defined in the left audio profile.

In various embodiments, the right audio profile can be different than the left audio profile. In various embodiments, the left audio profile is stored in the left non-volatile memory element of the ear-worn device and the right audio profile is stored in right non-volatile memory element of the ear-worn device. In various embodiments, the left audio profile and the right audio profile are stored in a memory element of the external device. In various embodiments, the left audio profile and the right audio profile are stored in a memory element of a remote server that is accessed by the external device.

In various embodiments, the device data 264, 266 can be stored locally such as in memory 104, 106. In various embodiments the device data 264, 266 can be different from each other, such as to account for physical or processing differences for a user's left and right ears (i.e., device 104 and device 106). In various embodiments, the device data 264, 266 can include device type data 272, 274. The device type data 272, 274 can include data related to the type of device 102 or the components included in the device 102. In various embodiments, the type of device 102 or the components within the device 102 can limit or enable the output or functionality of the device 102. As an example, the device 102 can include a receiver or speaker that is only capable of producing sounds within a specific frequency range, while frequencies outside of the range cannot be produced. In some embodiments, audio content can be modified to remove frequency ranges that cannot be output from the device 102, such as to decrease the size of the audio content without affecting the user's listening experience. As an example, some devices can include a receive that has a maximum output of 10 kHz, any of the audio data that is above 10 kHz can be removed without affecting the user's experience. In some cases, a receiver may have a maximum output below the user's hearing capabilities. As an example, a receiver may have a maximum output of 8 kHz and the user may be able to hear noises up to 10 kHz. Portions of the audio data that are above 8 kHz can be removed.

In various embodiments, only portions of the audio data that are able to be output by the device and within the hearing abilities of the user, such as according to the audio profile, can be saved to the device. As a result, portions of the audio data that are not able to be output by the device or that are not within the hearing range of the user according to the audio profile are not saved to the device.

In various embodiments, the network 118 can allow the external device 108 to send or receive data with the system server 120 and/or the database 222. In some embodiments, the external device 108 can receive the audio profile 256 over the network 118. In other embodiments, not shown in FIG. 2, the ear-worn device 102 can communicate over the network 118 to send or receive data with the external device 108, the system server 120, and/or the database 222.

In some embodiments, the ear-worn device 102 can communicate (send or receive data) with the external device 108 wirelessly. In some embodiments, the external device 108 can communicate (send or receive data) with the system server 120 wirelessly.

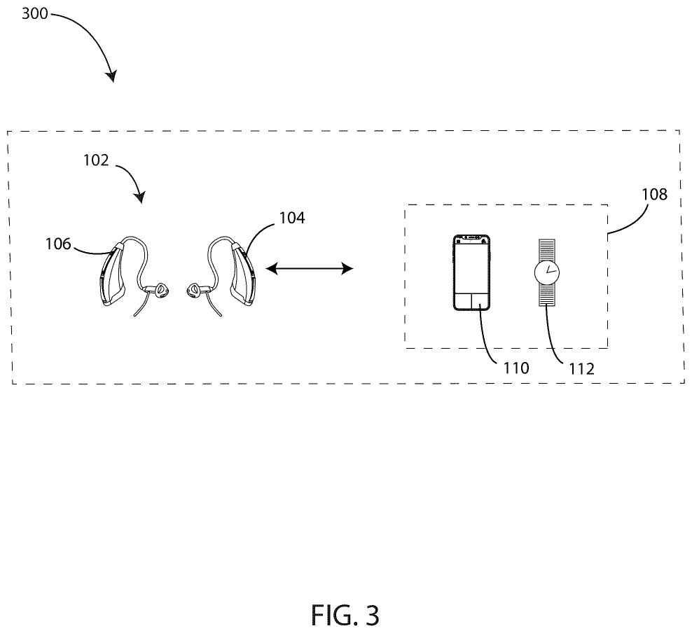

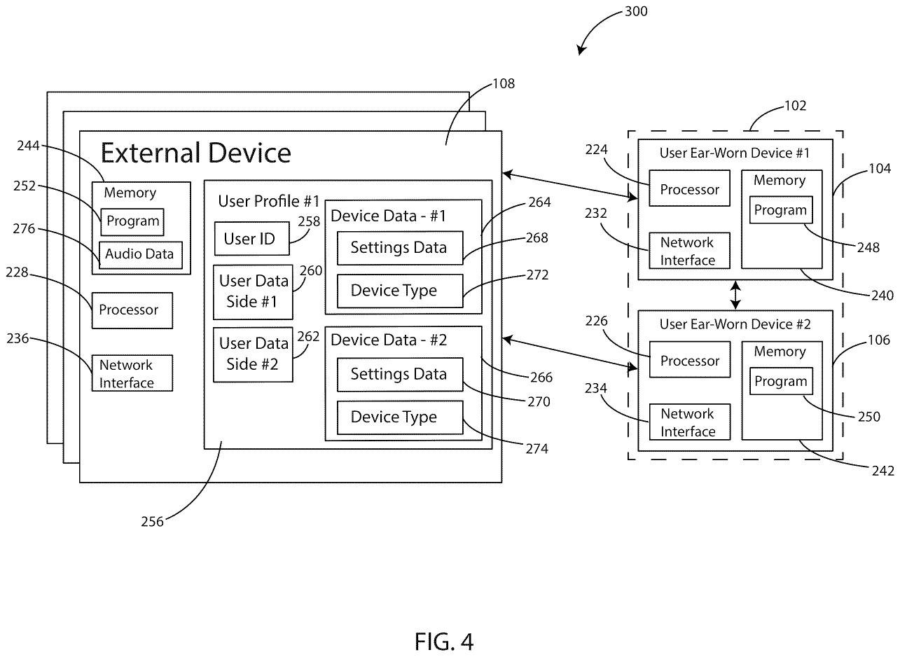

Hearing Assistance System with Audio Profile Stored on an External Device (FIG. 3-4)

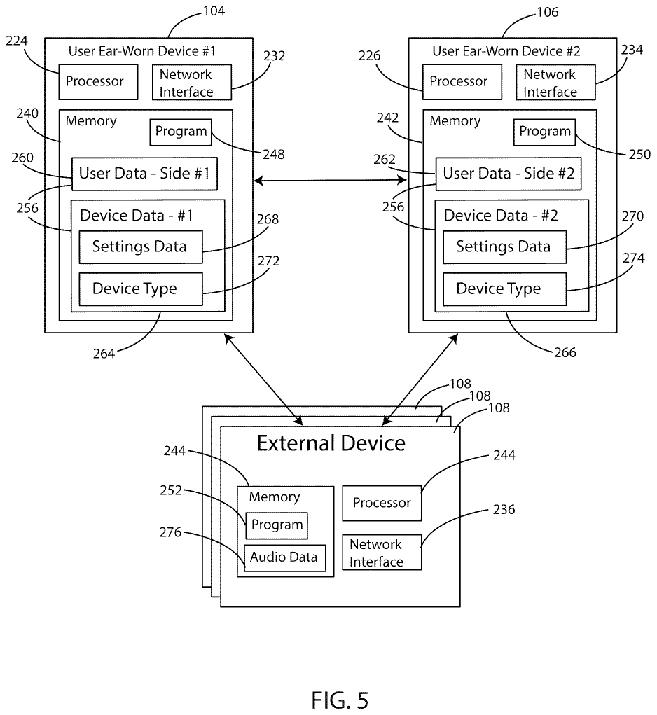

In some embodiments, audio data files on the external device 108 can be modified and sent to the ear-worn device 102 without accessing a system server 120 or a remote database. As shown in FIG. 3, in some embodiments, a hearing assistance system 300 can include an ear-worn device 102 and an external device 108. As an alternative or in addition to the audio profile 256 being stored on a system server 120 or in a remote database, the audio profile 256 can be stored on the external device 108 as shown in FIG. 4 and/or the audio profile 256 can be stored on the ear-worn device 102 as shown in FIG. 5.

FIG. 4 shows a schematic view of the hearing assistance system shown in FIG. 3 in accordance with various embodiments herein. In contrast to FIG. 2, in the system 300 shown in FIG. 4, the audio profile 256 for a user can be saved locally or in the external device 108. In the embodiment of FIG. 2, the external device 108 can access the audio profile 256 on a system server 120, such as to determine modifications to the audio content prior to uploading the audio content to the ear-worn device 102. In the embodiment of FIG. 4, the external device 108 can include the audio profile 256. It is also possible for the audio profile 256 to be saved on multiple external devices 108, such as shown in FIG. 4 where multiple external devices 108 can communicate with the same one or more ear-worn devices.

In various embodiments, a user may want to save audio content on an ear-worn device 102. The user can connect (wired or wirelessly) the ear-worn device 102 to the external device 108. The audio content 276 saved in the memory element 242 on the external device can be modified according to parameters included in the audio profile 256. The modified audio content can be sent to the ear-worn device 102 and stored on the ear-worn device for later playback.

Hearing Assistance System with Audio Profile Stored on an Ear-Worn Device (FIG. 5)

FIG. 5 shows a schematic view of the hearing assistance system shown in FIG. 3 in accordance with various embodiments herein. While FIG. 2 shows an audio profile stored on a system server and FIG. 3 shows an audio profile stored on an external device, in the system 300 shown in FIG. 5, the audio profile 256 for a user can be saved locally or on the ear-worn device 102, alternatively to or in addition to other storage locations. In the embodiment of FIG. 5, the external device 108 can access the audio profile 256 on the ear-worn device 102, such as to determine modifications to the audio content prior to sending the audio content to the ear-worn device 102 for storage. In various embodiments, portions of the audio profile 256 can be saved in different locations. As an example, the audio profile 256 can be split between the first ear-worn device 104 and the second ear-worn device 106 as shown in FIG. 5. For example, user data for side one 260 and device data for side one 264, can be stored on the first ear-worn device 104 while user data for side two 262 and device data for side two 266 can be stored on the second ear-worn device 106.

In various embodiments, a user may want to save audio content on an ear-worn device 102. The user can connect (wired or wirelessly) the ear-worn device 102 to the external device 108. The audio content 276 saved in the memory element 242 on the external device can be modified according to parameters included in the audio profile 256. The modified audio content can be sent to the ear-worn device 102 and stored on the ear-worn device for later playback.

In anticipation for modifying the audio content on the external device 108, prior to sending the modified audio content to the ear-worn device 102, the external device 108 can receive the audio profile 256 from the ear-worn device 102 or ear-worn devices 104, 106.

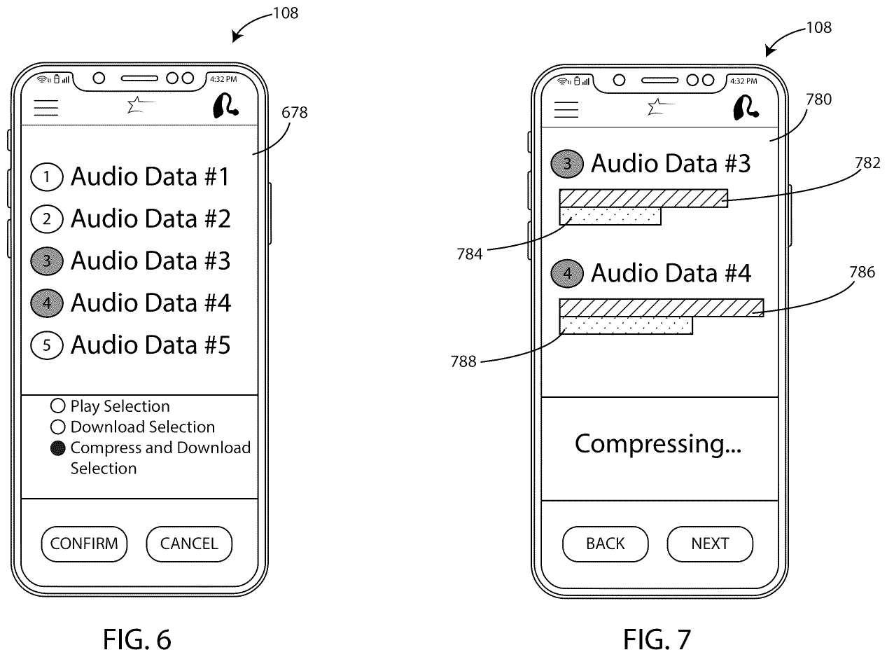

### User Interface Examples on External Devices (FIGS. 6-9)

In reference now to FIGS. 6-9, a series of user interfaces of an external device 108 are shown in accordance with various embodiments herein. FIGS. 6-9 show examples of the screens a user could be shown and use to provide input while performing various steps described herein.

FIG. 6 shows an interface 678 on the external device 108 to initiate the modification and transfer of audio content from the external device 108 to the ear-worn device 102. The user can select one or more audio data files to store on an ear-worn device 102 for later listening. In the example shown in the FIG. 6, the user has selected Audio Data #3 and Audio Data #4. The list of audio data can represent a list of songs, podcasts, audiobooks, playlists or the like.

Once the audio content has been selected, the external device 108 can modify the selected audio data files according to an audio profile as described herein. In various embodiments, the modification of the audio data can include compression, such that the modified audio data file is smaller in size than the unmodified audio data file.

FIG. 7 shows a user interface 780 depicting a rectangle representing the original size 782 of the audio data #3 and a rectangle with different shading representing the modified size 784 of the audio data #3. Similarly, the user interface 780 shows a rectangle representing the original size 786 of the audio data #4 and a rectangle with different shading representing the modified size 788 of the audio data #4. It can be seen that the modified sizes 784, 788 are smaller than the original sizes 782, 786.

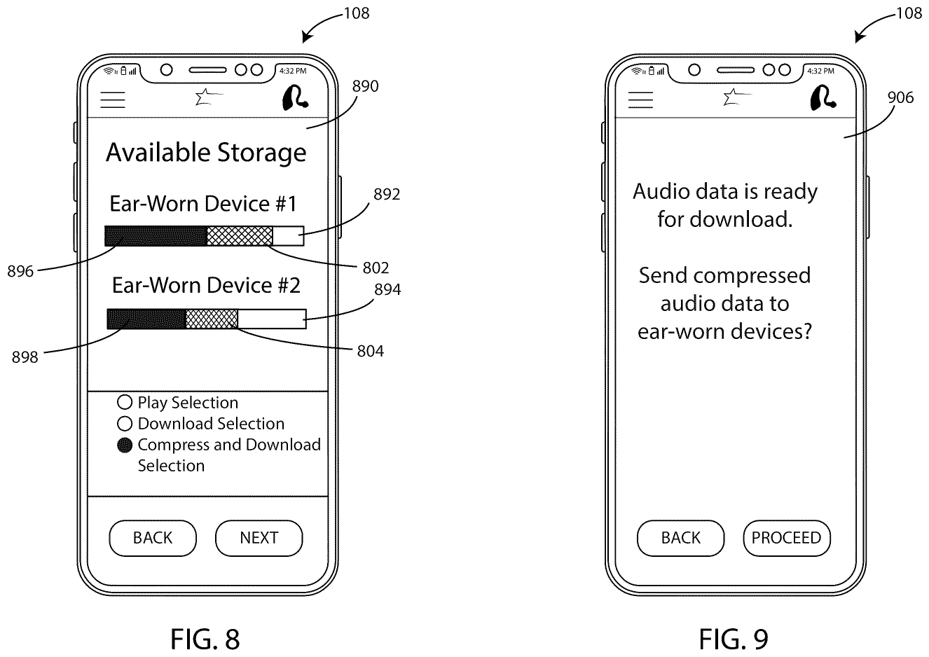

In some embodiments, the external device 108 can also display storage capacity and available storage of the ear-worn device 102, or of the first ear-worn device 104 and the second ear-worn device 106 as shown in FIG. 8. FIG. 8 shows a user interface 890 depicting the storage availability of the first and second ear-worn device 104, 106.

The first ear-worn device 104 can have a total storage 892, represented by the outline of a rectangle. The second ear-worn device 106 can have a total storage 894, represented by the outline of a second rectangle. The first ear-worn device 104 can have some portion of the total storage 892 occupied by data 896 already stored on the device, represented by a first shading pattern. Similarly, the second ear-worn device 106 can also have data 898, represented by the first shading pattern, stored on the device 106. This data can include previous audio data, instructions for the ear-worn device, or other data. The user interface 890 can further depict how much storage will be occupied by the selected and modified audio data 802, 804, represented by a second shading pattern, shown in FIGS. 6-7.

FIG. 8 further shows that the amount of data stored on the two devices 104, 106 can be different. As mentioned above, audio data files can be modified according to an audio profile of the ear that the user will use to listen to the audio. In the case of the example shown in FIG. 8, the second ear-worn device 104 has more available storage than the first ear-worn device. In some embodiments, this could be a result of more compression available for the second ear-worn device 106, such as due to the user having less hearing ability on the second ear which can result in additional bands of frequency removed from the data file compared to the first ear.

FIG. 9 shows a user interface 906 on the external device 108 in accordance with various embodiments herein. Once the audio data has been modified according to the audio profile, the modified audio data can be sent to the ear-worn device 102. The modified audio data can be stored on the ear-worn device 102 for future playback.

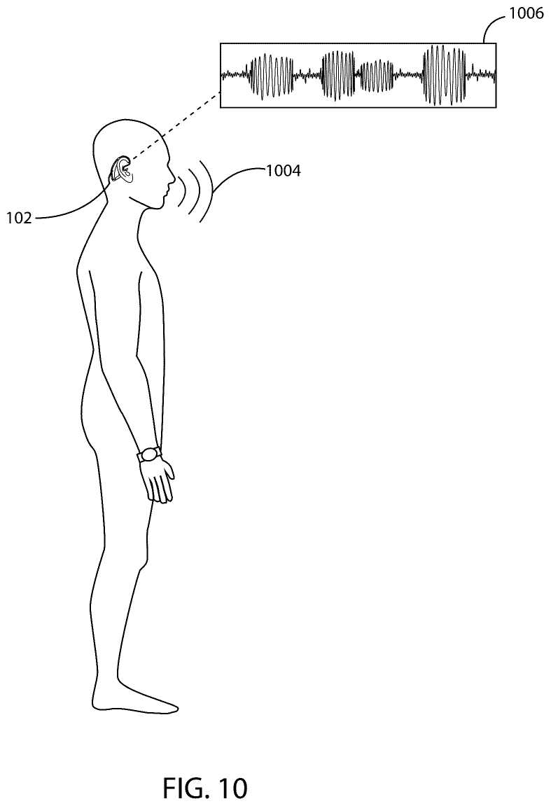

### Control of Ear-Worn Device (FIG. 10)

In some embodiments, the ear-worn device 102 can include a user interface. In some embodiments, the user interface of the ear-worn device can include one or more user input devices, such as buttons. In various embodiments, a user can manipulate the buttons to control the ear-worn device 102, such as to play stored audio content.

In some embodiments, such as shown in FIG. 10, the ear-worn device 102 can include a user input device such that the ear-worn device 102 can be controlled through voice commands. A user can tell the ear-worn device 102 what to do. The ear-worn device 102 can pick up the user's voice, process the signal, and respond accordingly. A user can speak 1004 and the ear-worn device 102 can interpret the words spoken by the user, such as by interpreting an audio signal 1006 that is heard by the ear-worn device 102. In some embodiments, the user can say, “Hey device, delete the 10^{th} song,” such as to delete a specific portion of the audio content that is stored. In some embodiments, the user can tell the ear-worn device to delete previously played audio content. In some embodiments, the user can tell the ear-worn device to record a song being streamed through an external device.

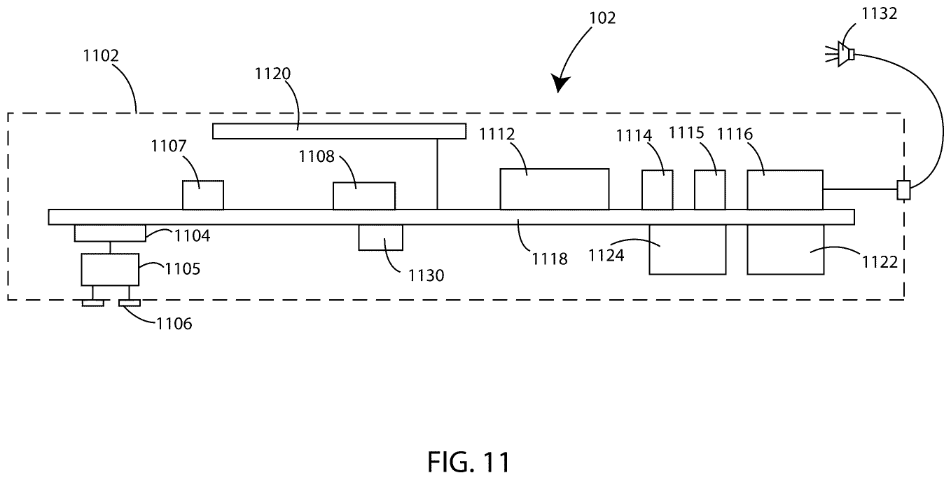

### Schematic of Internal Components of Ear-Worn Device (FIG. 11)

Referring now to FIG. 11, a schematic block diagram is shown with various components of an ear-worn device 102 in accordance with various embodiments. These components are enclosed within the housing 1102 of the ear-worn device 102. The block diagram of FIG. 11 represents an example ear-worn device. The ear-worn device 102 shown in FIG. 11 includes several components electrically connected to a circuit board 1118 (e.g., flexible circuit board) which is disposed within housing 1102. A power supply circuit 1104 can include a battery 1105, can be electrically connected to the circuit board 1118, and provides power to the various components of the ear-worn device 102. In some embodiments, one or more charging contacts 1106 are connected to the battery 1105 and are configured to interface with the charging contacts of a charger. In other embodiments, the charging contacts are not present and the battery 1105 is replaced when exhausted.

One or more microphones 1107 are electrically connected to the circuit board 1118, which provides electrical communication between the microphones 1107 and a digital signal processor (DSP) 1112. Among other components, the DSP 1112 incorporates or is coupled to audio signal processing circuitry configured to implement various functions described herein. One or more user input devices 1130 (e.g., on/off, volume, mic directional settings) are electrically coupled to the DSP 1112 via the circuit board 1118.

A sensor package 1114 can be coupled to the DSP 1112 via the circuit board 1118. The sensor package 1114 can include one or more different specific types of sensors. The ear-worn device 102 can include an IMU 1115. The IMU 1115 can be configured to detect a vibration sequence as a part of a pairing method for the wireless communication device 1108, among other useful data that can be ascertained from IMU 1115.

As used herein the term “inertial measurement unit” or “IMU” shall refer to an electronic device that can generate signals related to a body's specific force and/or angular rate. IMUs herein can include one or more accelerometers (3, 6, or 9 axis) to detect linear acceleration, a gyroscope to detect rotational rate, or both. In some embodiments, in the alternative or in addition, an IMU includes a magnetometer to detect a magnetic field.

An audio output device 1116 is electrically connected to the DSP 1112 via the circuit board 1118. In some embodiments, the audio output device 1116 comprises a speaker (coupled to an amplifier). In other embodiments, the audio output device 1116 comprises an amplifier coupled to a receiver 1132 adapted for positioning within an ear of a wearer. The receiver 1132 can include an electroacoustic transducer, speaker, or loudspeaker.

The ear-worn device 102 may incorporate a wireless communication device 1108 coupled to the circuit board 1118 and to an antenna 1120 directly or indirectly via the circuit board 1118. The communication device 1108 can be a high-frequency radio, such as a 2.4 GHz radio. The radio can conform to an IEEE 802.11 (e.g., WiFi®) or a Bluetooth® (e.g., Bluetooth® low energy, Bluetooth® 4.2 or 5.0, and Bluetooth® Long Range) specification, for example. It is understood that the ear-worn devices of the present disclosure can employ other radios, such as a 900 MHz radio.

Ear-worn devices of the present disclosure can be configured to receive streaming audio (e.g., digital audio data or files) from an electronic or digital source. Ear-worn devices herein can also be configured to switch communication schemes to a long-range mode of operation, wherein, for example, one or more signal power outputs may be increased, and data packet transmissions may be slowed or repeated to allow communication to occur over longer distances than that during typical modes of operation. Representative electronic/digital sources (also serving as examples of accessory devices herein) include an assistive listening system, a TV streamer, a radio, a smartphone, a cell phone/entertainment device (CPED), a pendant, wrist-worn device, or other electronic device that serves as a source of digital audio data or files.

The communication device 1108 can be configured to communicate with one or more external devices, such as a wireless communication device of a charging case, a wireless communication device of another ear-worn device, a wireless communication device of a smart phone, or a wireless communication device of another system, such as other systems discussed herein, in accordance with various embodiments. In various embodiments, the communication device 1108 can be configured to communicate with an external visual display device such as a smart phone, a video display screen, a tablet, a computer, or the like.

In various embodiments, the ear-worn device 102 can also include a control circuit 1122 and a memory storage device 1124. The control circuit 1122 can be in electrical communication with other components of the device. The control circuit 1122 can execute various operations, such as those described herein. The control circuit 1122 can include various components including, but not limited to, a microprocessor, a microcontroller, an FPGA (field-programmable gate array) processing device, an ASIC (application specific integrated circuit), or the like. The memory storage device 1124 can include both volatile and non-volatile memory. The memory storage device 1124 can include ROM, RAM, flash memory, EEPROM, SSD devices, NAND chips, and the like. The memory storage device 1124 can be used to store data from sensors as described herein and/or processed data generated using data from sensors as described herein, including, but not limited to, information regarding exercise regimens, performance of the same, visual feedback regarding exercises, and the like. The memory storage device 1124 can further be used to store audio data for later playback.

It is noted that the structure and housing of a second ear-worn device is not illustrated herein but may be similar to or identical to the first ear-worn device.

Ear-worn devices of the present disclosure can incorporate an antenna arrangement coupled to a high-frequency radio, such as a 2.4 GHz radio. The radio can conform to an IEEE 802.11 (e.g., WiFi® standard) or Bluetooth® standard (e.g., BLE, Bluetooth® 4.2 or 5.0) specification, for example. It is understood that ear-worn devices of the present disclosure can employ other radios, such as a 900 MHz radio. Ear-worn devices of the present disclosure can be configured to receive streaming audio (e.g., digital audio data or files) from an electronic or digital source. Representative electronic/digital sources (also referred to herein as accessory devices) include an assistive listening system, a TV streamer, a radio, a smart phone, a cell phone/entertainment device (CPED) or other electronic device that serves as a source of digital audio data or files.

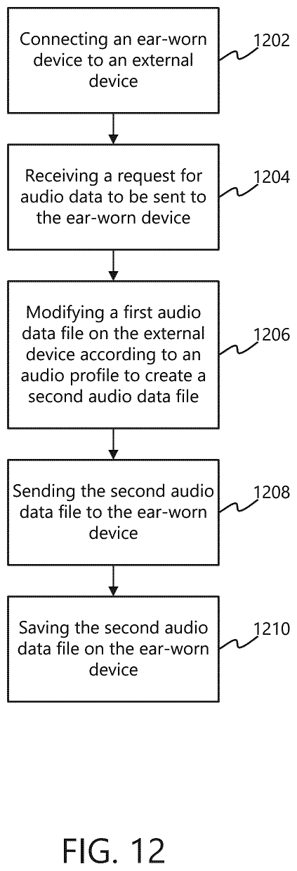

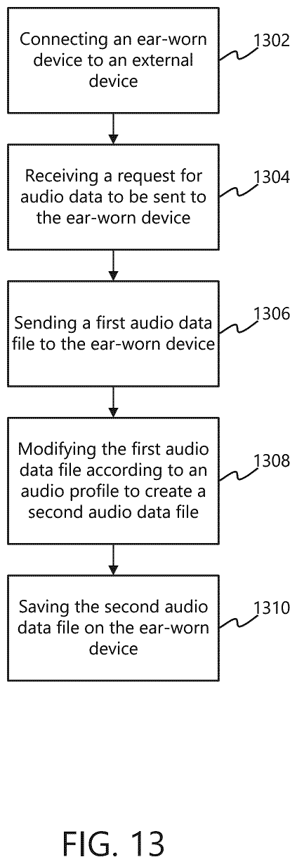

### Methods of Modifying Audio Data Using an Audio Profile (FIGS. 12-13)

FIG. 12 shows a flow chart of a method of saving audio data on an ear-worn device in accordance with various embodiments herein. The method can include connecting an ear-worn device 102 to an external device 108, step 1202. The connection between the ear-worn device 102 and the external device 108 can be a wired connection or a wireless connection.

The method can include receiving a request for audio data to be sent from the external device to the ear-worn device. In various embodiments, the external device 108 receives a request for audio data (e.g., audio content) that is stored on the external device 108 to be sent to the ear-worn device 102, step 1204. In various embodiments, the request can be a result of user input, such as by selecting one or more audio data files on the external device.

Prior to sending the audio data to the ear worn device, the audio data can be modified. In various embodiments, the method includes modifying a first audio data file on the external device in accordance with parameters defined in an audio profile to create a second audio data file, step 1206. In various embodiments, the external device can receive the audio profile from a system server. In various embodiments, the audio profile is stored on the external device 108 prior to the audio data being requested. In various embodiments, modifying the audio data can include compressing the audio data, such as to reduce the amount of memory needed to store the audio data file. In various embodiments, the second audio data file is smaller than the first audio data file.

Once the audio data has been modified to create the second audio data file, the method can include sending the second audio data file from the external device to the ear-worn device, step 1208. The method can further include saving the second audio data in a non-volatile memory element of the ear-worn device 102, step 1210.

FIG. 13 shows a flow chart of a method of saving audio data on an ear-worn device in accordance with various embodiments herein. The method can include connecting an ear-worn device 102 to an external device 108, step 1302. The connection between the ear-worn device 102 and the external device 108 can be a wired connection or a wireless connection.

The method can include receiving a request for audio data to be sent from the external device to the ear-worn device. In various embodiments, the external device 108 receives a request for audio data (e.g., audio content) that is stored on the external device 108 to be sent to the ear-worn device 102, step 1304. In various embodiments, the request can be a result of user input, such as by selecting one or more audio data files on the external device.

The method can further include sending the first audio data from the external device 108 to the ear-worn device 102, step 1306.

Once the audio data file is on the ear-worn device 102, the ear-worn device can modify the audio data file. The method can include modifying the first audio data in accordance with parameters defined in an audio profile to create a second audio data file, step 1308. In various embodiments, modifying the audio data includes compressing at least a portion of the audio data. In various embodiments, the audio profile is stored on the ear-worn device 102. In various embodiments, the second audio data file is smaller than the first audio data file.

The method can further include saving the second audio data in a non-volatile memory element of the ear-worn device 102, step 1310.

In various embodiments, the ear-worn device 102 can be capable of taking streamed audio and recording the streamed audio to the non-volatile memory of the ear worn device 102.

In various embodiments, operations described herein, and method steps can be performed as part of a computer-implemented method executed by one or more processors of one or more computing devices. In various embodiments, operations described herein, and method steps can be implemented instructions stored on a non-transitory, computer-readable medium that, when executed by one or more processors, cause a system to execute the operations and/or steps.

### Ear-Worn Devices

The term “ear-worn device” shall refer to devices worn on or in the ear. Ear-worn devices can also be referred to as “ear-wearable devices”. Though not required, in some embodiments, ear-worn devices can aid a person with hearing, such as a hearing assistance devices or hearing aids. Examples of hearing assistance devices are devices that can aid a person with impaired hearing or that can produce sounds, optimized sounds, or processed sound for persons with normal hearing. Ear-worn devices herein can include hearables (e.g., wearable earphones, headphones, earbuds, virtual reality headsets), hearing aids (e.g., hearing instruments), cochlear implants, and bone-conduction devices, for example. Hearing assistance devices that are also custom ear-worn devices include, but are not limited to, in-the ear (ITE), in-the-canal (ITC), invisible-in-canal (IIC), or completely-in-the-canal (CIC) type hearing assistance devices, or some combination of the above. Ear-worn devices can also be used to block sound or even be unrelated to hearing. In some embodiments herein, an ear-worn device may also take the form of a piece of jewelry, or a component of frames of glasses, that may be attached to the head on or about the ear. Ear-worn devices can be worn within the ear in some embodiments.

Custom ear-worn devices include at least one component, such as a shell, that is customized to the user's anatomy. Custom ear-worn devices provide a number of advantages to the user. They can produce sound that seems more natural to the user because the hearing aid receiver, or speaker, is closer to the eardrum than non-custom ear-worn devices. This proximity enables a higher-quality sound at a lower volume. Another contributor to quality is that the microphone can collect sound from in the ear itself, rather than from behind the ear. This takes advantage of the ear's pinna, the external part of the ear, to funnel sounds to the microphone. The microphone is also more shielded from wind in some embodiments. In various embodiments, custom ear-worn devices are formed as a single housing, rather than two parts, and can therefore be easier for the user to put on.

Examples of different types of custom ear-worn devices include the following, which are mentioned from larger to smaller: in-the-ear (ITE) ear-worn devices, in-the-canal (ITC) ear-worn devices, completely-in-canal (CIC) ear-worn devices, and invisible (IIC) ear-worn devices. Each of these custom ear-worn devices has a different size and mates with a differently sized portion of the user's ear cavity.

### Audio Profile

An audio profile can include user data and device data. The audio profile can include data related to the settings, abilities, and limitations of the ear-worn device and the user. In various embodiments, the audio profile can be stored in one or more of the following: the ear-worn device, an external device, or in an external database, such as on an external server.

The user data can include the user's hearing profile data, such as the user's hearing abilities and limitations. In various embodiments, the audio profile can include the user's hearing abilities and limitations for both the right side/ear and the left side/ear, such that a first ear-worn device 104 and a second ear-worn device can be configured differently to account for differences in the user's hearing abilities or limitations. The audio profile can include audiogram data of the user. The audiogram data can include levels of decibels that are audible to the user as a function of frequency, such as which ranges of frequencies the user can hear, which ranges of frequencies the user has difficulty hearing, and which ranges of frequencies the user cannot hear. In various embodiments, audio profile comprises user hearing profile data relating to hearing capabilities of the user of the ear-worn device. In various embodiments, the user data comprises at least one of a minimum loudness threshold for audibility for a user ear at one or more frequencies or frequency ranges, or one or more frequency ranges at which the user's ear does not have functional hearing.

A user's hearing ability can change over time, such as decline. As a result, the audio profile can be updated. In some cases, additional data can be removed from an audio data file compared to the pre-update audio profile, such as in the modification step prior to saving the audio data file on the ear-worn device.

The device data can include limitations and abilities of the ear-worn device. In some embodiments, the device data can include device parameters. In various embodiments, the device parameters can include or more of ear-worn device model, ear-worn device receiver type, ear-worn device open/closed fit data, the high frequency output limit of the ear-worn device, the low-frequency output limit of the ear-worn device, and decibel output limits of the ear-worn device. Open/closed fit data can include an indication that the device is a closed fit, the device is an open fit, or that the device is switchable between an open fit and a closed fit.

### Example Compression Schemes

As previously mentioned, audio data on an external device can be modified according to the audio profile. The audio data can be modified based on the limitations or abilities of the ear-worn device and/or the user, both of which can be included in the audio profile.

The ear-worn device and/or the external device can be configured to provide digital signal processing including compression and/or amplification. Compression is generally regarding file size, whereas amplification is generally regarding user experience. Compression can be provided to reduce the size of an audio data file. In some embodiments, compression can result in the modified audio data file being at least 5%, 10%, 15%, 20%, 25%, 30%, 40%, or 50% smaller than the original unmodified audio data file or being smaller by ranges between these values. Amplification can include a gain of greater than one to make it easier for a user to hear a sound, such as sounds in a defined frequency range.

In various embodiments, the compression of audio data can include removing data that is not useful to the user. Compression can include removing portions of the data that are not needed to reproduce the desired sound for the user, where the sound is what the user experiences. In various embodiments, the audio data file is modified by removing portions of the audio data. The portions of audio data are removed in accordance with device limitations or portions of audio data are removed in accordance with user limitations.

In some embodiments, the audio data can include multichannel audio data. As an example, some audio data can be recorded in two channels (e.g., stereo). In other examples, some audio data can be recorded in more than two channels, such as 5.1, 7.1, 7.1.2, or 7.2.4. In some embodiments, the audio data can include a stereo signal, such as having a designated portion of the audio data intended for the left side and a designated portion of the audio data intended for the right side. It should be understood that splitting an audio data signal into two different portions (right and left) is not considered compression in this instance, since the audio data file size in congregant is not smaller than the unsplit audio data file.

Compression of a stereo signal can be side-dependent. As an example, a user might not be able to hear any sounds in a range of 8 kHz to 10 kHz with their left ear, but the user can hear sounds in this range with their right ear. As will be discussed below, for such an example, a modified audio data file stored in a left ear-worn device can have sounds in the range of 8 kHz to 10 kHz removed from the data file to reduce the file size. However, the sounds in the range of 8 kHz to 10 kHz can remain part of the audio data file for a right ear-worn device.

In various embodiments, the compression can include removing all or some portions of the audio data that are above a high-frequency threshold, such as above a high-frequency threshold defined in the audio profile. As an example, if an ear-worn device has an upper frequency limit of 10 kHz, the step of modifying the audio data file can include deleting or removing portions of the audio data file that relate to frequencies over 10 kHz. Similarly, if a user or a user's ear has an upper frequency limit of 8 kHz, the step of modifying the audio data file can include deleting or removing portions of the audio data file that relate to frequencies over 8 kHz. In an example where the device and the user both have an upper frequency limit, the compression can use the lower frequency of the two. In various embodiments, the same modification can be applied to a lower-frequency limit. In various embodiments, the same modification can be applied to an embedded frequency range, such as a range of frequencies within a lower-frequency limit and an upper frequency that a user cannot hear.

In embodiments where an embedded frequency limit is removed, the data related to the portions of audio above the upper end of the frequency limit (portions of the data, which remain in the modified audio data file) can be frequency shifted down. As an example, in some embodiments, the ear-worn device can have a natural frequency shift (frequency shift a range up). In another example, in some embodiments, the ear-worn device can have programming to set a flag or indication on a file or in the parameters of a device for a universal rule, such as audio content is always processed in this specific manner (removal of gap), such that whenever music is being played, the ear-worn device needs to frequency shift up designated portions of the audio content. For example, an audio profile that indicates an inability to hear frequencies between 6 kHz and 7 kHz may result in all audio content stored on an associated ear-worn device to have audio content from 7 kHz and above to be shifted down 1 kHz. In other words, 7 kHz will be translated or shifted down to 6 kHz, 8 kHz will be translated or shifted down to 7 kHz, etc. Furthermore, when such audio content is played back by the ear-worn device, the ear-worn device may shift audio data from 6 kHz and above up by 1 kHz. Accordingly, storage requirements of the audio data can be further reduced in situations where embedded frequency limits are removed.

In various embodiments, a particular device, such as an open-fit device, may not be capable of producing low-frequency sounds below a low-frequency threshold. A low-frequency threshold can be stored in the device data. In addition, or alternatively, an open-fit indication can be stored in the device data. The step of modifying the audio data file can include deleting or removing portions of the audio data file that are below the low-frequency threshold or are not possible for an open-fit device to generate.

### Neural Audio Codecs

As an alternative or in addition to the previously discussed methods of compression, various embodiments can employ a neural audio codec (“NAC”) to compress an audio file. In some embodiments, a neural audio codec can be used independently of the other compression methods provided herein, such as according to an audio profile including parameters of an ear-worn device or user hearing profile data. In other embodiments, a neural audio codec can be used in combination with an audio profile including parameters of an ear-worn device and/or user hearing profile data.

Examples of neural audio codecs being used in association with ear worn devices are described in U.S. Application No. 63/994,496, titled, “EXTERNAL PROCESSING WITH NEURAL AUDIO CODECS,” filed on Mar. 2, 2026 and having Attorney Docket Number ST1158PRV, U.S. Application No. 63/994,546, titled, “HEARING LOSS COMPENSATION USING NEURAL AUDIO CODECS,” filed on Mar. 2, 2026 and having Attorney Docket Number ST1159PRV, and U.S. Application No. 63/994,532, titled, “FOUNDATION MODELS FOR AUDIO PROCESSING,” filed on Mar. 2, 2026 and having Attorney Docket Number ST1160PRV, the contents of which for each application are herein incorporated by reference in their entirety.

A neural audio codec (NAC) can be implemented as a neural-network-based audio compression and decompression system that in some embodiments replaces, in whole or in part, traditional hand-engineered digital signal processing components. In various embodiments, a NAC includes an encoder configured to receive an input audio signal, such as a time-domain waveform or a transform-domain representation (for example, a WOLA-based time-frequency representation, or weighted overlap add-based time-frequency representation), and to analyze the input audio signal using one or more neural network layers (for example, one-dimensional convolutional layers followed by normalization and non-linear activation) to produce a latent-domain audio signal. In some embodiments, the latent-domain audio signal can include a sequence of multi-dimensional feature vectors or feature maps that are down-sampled in time and/or reduced in dimensionality relative to the original signal, and that capture local time-frequency structure and higher-level characteristics, such as speech content, timbre, and background noise type.

A quantizer, which in some embodiments is implemented as a residual vector quantizer or other vector-quantization module, is configured to discretize the latent-domain audio signal into a plurality of audio tokens by mapping each latent vector to one or more codebook entries from one or more learned codebooks. The selected codebook entries are represented as discrete indices, referred to herein as audio tokens, such that a sequence of audio tokens represents at least a portion of the audio signal in a compact symbolic form suitable for storage, transmission, and downstream processing.

A decoder, which may be implemented as a neural network that mirrors, at least in part, the structure of the encoder (for example, via up-sampling and convolutional blocks), is configured to receive the plurality of audio tokens and, in some embodiments, one or more auxiliary inputs, and to decompress or reconstruct an output audio signal from the tokens. The encoder, quantizer, and decoder can be trained end-to-end under a constraint on token rate or bitrate so that the reconstructed audio produced by the decoder is perceptually similar to the original input audio (i.e., first audio data file), for example using one or more of multi-scale STFT loss functions, time-domain loss functions, adversarial loss functions, and feature-matching loss functions. In various embodiments described herein, this NAC-based encoder-quantizer-decoder chain can form part of the processing apparatus of an ear-worn device and can operate as a foundation model that tokenizes audio data on the external device into audio tokens which are then provided to the ear-worn device for further processing. In conditional NAC (CNAC) configurations, the decoder is further configured to condition its reconstruction on at least one auxiliary input, such as an audiogram, an insertion-gain profile, or an environment classification, to render an output audio signal that can be personalized to the hearing-loss characteristics of the wearer and/or adapted to the parameters of the ear-worn device, thereby enabling the ear-worn device to include significantly more audio data available to the user without placing additional demand on the memory component of the ear-worn device.

In various embodiments, the encoder is stored on the external device 108. In various embodiments, the quantizer is stored on the external device 108. In various embodiments, the decoder is stored on the ear-worn device 102. The encoder and the decoder can be part of the same codec.

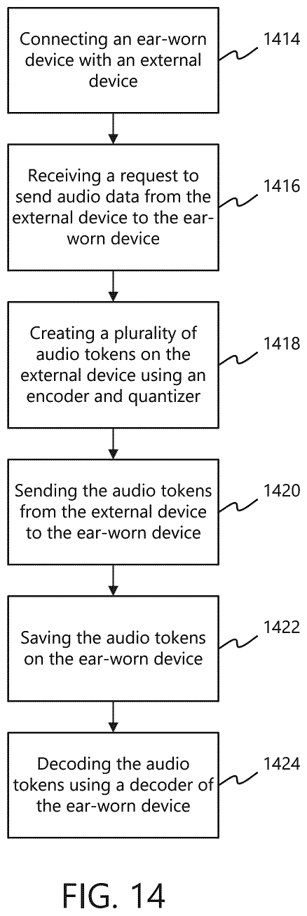

FIG. 14 shows a flow chart of a method of saving audio data on an ear-worn device in accordance with various embodiments herein. The method can include connecting an ear-worn device 102 to an external device 108, step 1414. The connection between the ear-worn device 102 and the external device 108 can be a wired connection or a wireless connection.

The method can include receiving a request for audio data to be sent from the external device to the ear-worn device. In various embodiments, the external device 108 receives a request for audio data (e.g., audio content) that is stored on the external device 108 to be sent to the ear-worn device 102, step 1416. In various embodiments, the request can be a result of user input, such as by selecting one or more audio data files on the external device.

The method can further include using a neural audio codec to reduce the amount of memory needed to store audio data files on the ear-worn device. The audio data files that are stored on the ear-worn device while not the exact same as the original audio data files stored on the external device can be decoded to produce an audio output to the user that is nearly the same as the original audio data files. The method can include creating audio tokens on the external device by encoding a first audio data file, such as by using an encoder of the neural audio codec to generate a latent-domain audio representation of the first audio data file and quantizing the latent-domain audio representation using a quantizer of the neural audio codec to map latent vectors to corresponding entries of one or more learned codebooks and to output a sequence of discrete indices corresponding to the selected codebook entries, the discrete indices forming a plurality of audio tokens representing the first audio data file in a compressed form, step 1418.

The method can further include sending the audio tokens from the external device 108 to the ear-worn device 102, step 1420.

In some embodiments, the audio tokens can be saved in a memory element, such as a non-volatile memory element, of the ear worn device, 1422.

Once the audio tokens are on the ear-worn device 102, the ear-worn device can decode the audio tokens using a decoder that is matched with the encoder on the external device, step 1424. Once the audio tokens have been decoded, the audio can be played or output by a receiver of the ear-worn device.

In various embodiments, operations described herein, and method steps can be performed as part of a computer-implemented method executed by one or more processors of one or more computing devices. In various embodiments, operations described herein, and method steps can be implemented instructions stored on a non-transitory, computer-readable medium that, when executed by one or more processors, cause a system to execute the operations and/or steps.

It should be noted that, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

As used herein, the recitation of numerical ranges by endpoints shall include all numbers subsumed within that range (e.g., 2 to 8 includes 2.1, 2.8, 5.3, 7, etc.).

The headings used herein are provided for consistency with suggestions under 37 CFR 1.77 or otherwise to provide organizational cues. These headings shall not be viewed to limit or characterize the invention(s) set out in any claims that may issue from this disclosure. As an example, although the headings refer to a “Field,” such claims should not be limited by the language chosen under this heading to describe the so-called technical field. Further, a description of a technology in the “Background” is not an admission that technology is prior art to any invention(s) in this disclosure. Neither is the “Summary” to be considered as a characterization of the invention(s) set forth in issued claims.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

1. A method of saving audio data on an ear-worn device, comprising:
connecting an ear-worn device to an external device;
receiving a request for audio data to be sent from the external device to the ear-worn device;
modifying a first audio data file on the external device to create a plurality of audio tokens, wherein the data size of the plurality of tokens is smaller than the first audio data file;
sending the audio tokens from the external device to the ear-worn device; and
saving the audio tokens in a non-volatile memory element of the ear-worn device.

2. The method of claim 1, wherein the modifying the first audio data file to create the plurality of audio tokens utilizes an encoder and a quantizer stored on the external device.

3. The method of claim 2, further comprising:
decoding the audio tokens on the ear-worn device utilizing a decoder that corresponds with the encoder of the external device.

4. The method of claim 3, further comprising:
producing an audio output with a receiver of the ear-worn device based on the decoded audio tokens.

5. The method of claim 1, wherein the external device comprises a smartphone.

6. The method of claim 1, wherein the requested audio data file comprises at least one of a song, a podcast, an audio book, a playlist of songs, or a playlist of podcasts.

7. The method of claim 1, wherein the ear-worn device comprises a left ear-worn device and a right ear-worn device, wherein the left ear-worn device comprises a left non-volatile memory element, and the right ear-worn device comprises a right non-volatile memory element.

8. The method of claim 7, wherein the first audio data file comprises multichannel audio data comprising two or more channels of audio data, wherein modifying the first audio data further comprises separating the two or more channels of audio data into a right channel audio tokens and a left channel audio tokens,
wherein saving the audio tokens comprises saving the right channel audio tokens in the right non-volatile memory element and saving the left channel audio tokens in the left non-volatile memory element.

9. The method of claim 7, further comprising modifying the first audio data prior to creating audio tokens according to an audio profile.

10. The method of claim 9, wherein the audio profile comprises parameters of the ear-worn device.

11. The method of claim 10, wherein the audio profile comprises device parameters that define a frequency range output of the ear-worn device, and modifying the first audio data file includes removing audio content that cannot be output from the ear-worn device based on the device parameters.

12. The method of claim 9, wherein the audio profile comprises data related to a user's hearing capabilities.

13. The method of claim 12, wherein the user's hearing capabilities comprises at least one of a frequency range that the user cannot hear, a frequency range that the user has trouble hearing, and a frequency range that the user can hear.

14. The method of claim 1, wherein the non-volatile memory element is configured to store at least 1 MB of data and not more than 1 GB of data.

15. The method of claim 1, wherein the audio tokens data storage requirement is at least 30% smaller than the first audio data.

16. The method of claim 1, wherein the encoder comprises a neural network.

17. The method of claim 1, wherein the decoder comprises a neural network.

18. An ear-worn device comprising:
a wireless communication device to receive data from one or more external devices;
a non-volatile memory to store received data;
a speaker to output sound based on received audio signals; and
control circuitry comprising one or more processors and operatively coupled to the wireless communication device, the non-volatile memory, and the speaker, the control circuitry configured to:
receive a plurality of audio tokens using the wireless communication device, the plurality of audio tokens representative of an audio data file;
save the audio tokens in the non-volatile memory element;
generate an audio signal based on the plurality of audio tokens using a decoder comprising a neural network; and
provide the audio signal to the speaker for sound generation.
